(19) United States
(12) Patent Application Publication
(10) Pub. No.: US 2011/0139267 A1
(43) Pub. Date: Jun. 16, 2011

(54) System and Apparatus for Controlled Siphoning

(75) Inventor: Jean-Paul Gagnon, Jonquiere (CA)

(73) Assignee: ALCAN INTERNATIONAL LIMITED, Montreal (CA)

(21) Appl. No.: 12/968,866

(22) Filed: Dec. 15, 2010

(30) Foreign Application Priority Data
Dec. 16, 2009 (CA) 2688730

(51) Int. Cl. F16L 43/00; F16K 31/12

(52) U.S. Cl. 137/136; 251/12

(57) ABSTRACT

A siphoning operation is controlled to meet a target flow rate of liquid being siphoned into a container having a headspace to which a vacuum is induced with an ejector. The incremental mass of liquid siphoned into the container is monitored and the vacuum applied to the container is continuously adjusted. A vacuum regulator responsive to an electric current-to-pressure converter which is coupled to a control unit is provided to control the flow of pressurized fluid delivered to the ejector.

### CROSS-REFERENCE TO RELATED APPLICATION

This application claims priority to and the benefit of Canada Patent Application No. 2,688,730, filed Dec. 16, 2009, which application is incorporated herein by reference in its entirety and made part hereof.

### TECHNICAL FIELD

This application relates to the siphoning of liquids, in particular to any liquid having a supernatant liquid. In the context of aluminium production, a particular application relates to the siphoning of molten aluminium from electrolysis cells, in which there is a supernatant liquid electrolytic bath.

### BACKGROUND OF THE ART

A problem which occurs during siphoning of aluminium is that the metal layer has a limited depth and the volumetric flow during siphoning is difficult to control. While it is desirable on the one hand to increase production flow rates and to minimize blockages, if the flow is not optimized, a poorly managed flow rate can result in bath being entrained with the metal. Bath entrainment has many negative effects on electrolytic cell processing and should ideally be minimized.

Siphoning of aluminium metal from an operating electrolytic cell is usually done with a crucible which is positioned with a crane or a suitable vehicle. The crucible has an integral siphon which is inserted into an electrolytic cell at the depth of the metal. Once positioned, a vacuum is induced into the crucible, usually using an air ejector whereby the metal is aspired through the siphon. The air flow through the air ejector is controlled manually using a valve on a compressed air supply.

In practice, a stable metal flow is not obtained and very large fluctuations can be observed during siphoning of a single cell and of adjoining cells.

Some of the factors which can explain some of the variations in flow rate are, for example: the position of the crucible relative to the metal/bath interface; any obstructions limiting free flow of metal into the siphon inlet such as surface variations on the floor of the electrolytic cell or lumps of solidified bath; variations in air temperature during siphoning; variations during siphoning in how well the crucible is sealed; variations in air pressure supply; crusting of siphons from bath entrainment, to name a few.

Accordingly, there is a need to provide means for siphoning a liquid, aluminium in particular, with a pre-defined metal flow rate while minimizing fluctuations to the flow rate.

### SUMMARY

In accordance with one aspect, there is provided a system for controlled siphoning of a liquid to be transferred at a pre-determined target flow rate Q into a container having a siphon communicating with a headspace for the container, the system having: an air ejector coupled to a source of compressed air and in fluid communication with the headspace; weighing means for measuring the weight of the container during siphoning; a control unit operatively connected to said weighing means for receiving weight measurements and calculating instantaneous liquid flow rates q of liquid being siphoned into the container, the control unit having an output providing target vacuum set points V for continuously adjusting a flow rate of the compressed air flowing through the air ejector such that the actual flow rate q of the liquid being drawn into the container generally corresponds to said target flow rate Q; and a vacuum regulator provided between the source of compressed air and the air ejector, and operatively connected to the control unit and a vacuum feedback pressure line from the headspace for regulating the flow of compressed air delivered to the air ejector in response to vacuum pressure changes in the headspace and to the target vacuum set-points V fed to the vacuum regulator by the control unit.

In accordance with a further aspect, there is provided a system for controlled siphoning of a liquid to be transferred at a pre-determined target flow rate Q into a container having a siphon communicating with a headspace for the container, the system having: an ejector operatively connected to a source of motive fluid, the ejector being in fluid communication with the headspace to cause liquid to be drawn into the container through the siphon as the motive fluid flows through the ejector, a flow regulator provided between the source of motive fluid and the ejector for regulating the flow of motive fluid fed to said ejector, thereby providing for the adjustment of a vacuum pressure at said headspace; a sensor for sensing an operating parameter indicative of an actual flow rate (q) of the liquid drawn into the container; and a control unit adapted to: use the operating parameter from the sensor to determine an adjustment value of a flow rate of the motive fluid for the actual flow rate (q) to generally correspond to the predetermined target flow rate (Q), and controlling the flow regulator to regulate the flow rate of the motive fluid in accordance with the adjustment value.

In accordance with a still further aspect, there is provided a valve actuator adapted to be coupled to a valve assembly having a housing defining a primary inlet and an outlet, a valve member received in said housing for regulating a fluid flow between the primary inlet and the outlet, and a valve stem extending from the valve member through the housing; the valve actuator having a vacuum chamber sealed from a pressure chamber, the vacuum chamber having a vacuum chamber inlet and a first diaphragm responsive to fluid pressure in said vacuum chamber, the first diaphragm being coupled to the valve stem, the pressure chamber having a secondary inlet and a second diaphragm responsive to fluid pressure in said pressure chamber and coupled to said valve stem, both said first and second diaphragms being adapted to move the valve stem to control the position of the valve member and determine the fluid flow through the outlet of the valve assembly.

### BRIEF DESCRIPTION OF THE DRAWINGS

FIG. 1 is a schematic drawing showing various components in a system suited for siphoning aluminium metal from an electrolytic cell, in accordance with an embodiment of the invention;

FIG. 2 is a screen print of operating parameters monitored by a programmable logic controller forming part of the system of FIG. 1; and

FIG. 3 is a sectional view of a vacuum regulator and associated valve assembly forming part of the system shown in FIG. 1.

### DESCRIPTION OF THE PREFERRED EMBODIMENTS

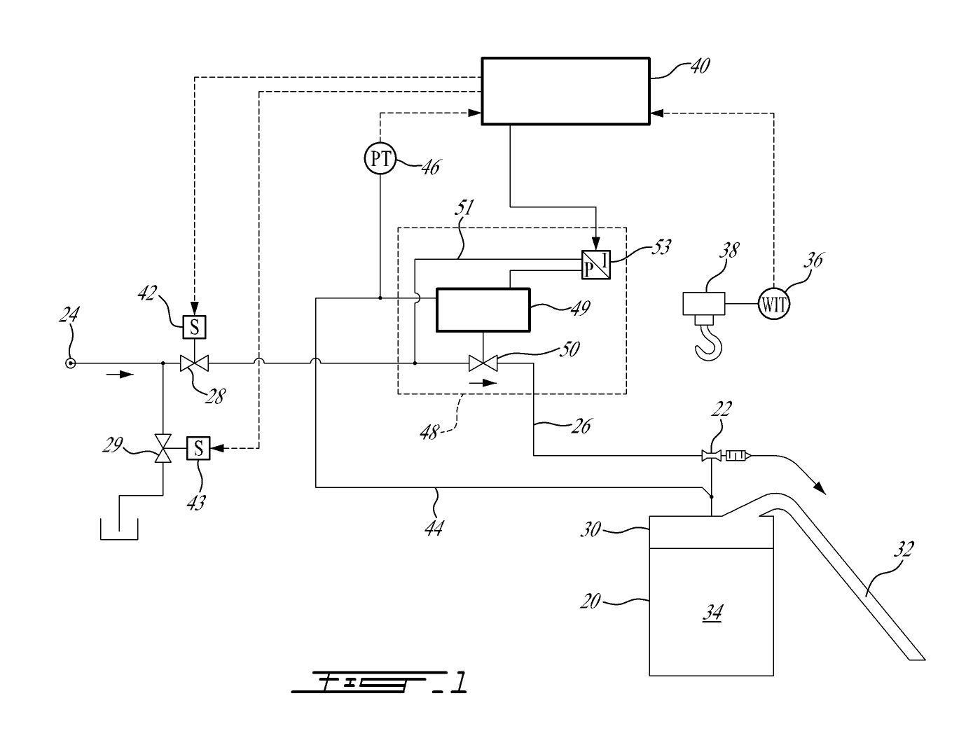

A system for controlled siphoning will now be described with reference to the schematic drawing of FIG. 1. A vacuum may be produced in a crucible 20 using an eductor or an air ejector 22 connected to a source of pressurized fluid, such as a compressed air supply 24 through a feed line 26. It is understood that the ejector 22 could be connected to various sources of pressurized fluids and that the working/motive fluid is not limited to compressed air. Main compressed air directional valves 28 & 29 are provided to close or open the compressed air supply 24, as needed, and to purge the air supply lines of any condensation.

Siphoning takes place when compressed air is allowed to flow through the air ejector 22 to atmosphere. The air ejector 22 has a suction port coupled to a headspace 30 in the crucible 20 and thereby induces a vacuum which changes according to variable conditions, as previously described. A siphoning tube 32 operatively connected to the headspace 30 draws liquid metal 34 from an electrolytic cell (not shown) and fills the crucible 20 with a predefined mass of metal. The mass of metal to be siphoned is predefined in accordance with standard operating procedures and will depend on the production levels of the electrolytic cell and minimum metal levels required to maintain a cell in operation. The incremental mass of the crucible 20 may be determined by a scale 36 coupled to a crane 38 from which the crucible 20 is suspended, in use. Other types of weighing devices or weight transducers could be used as well. When the target mass M of metal 34 has been aspired, for example 2500 kg, the compressed air supply 24 is closed with main compressed air directional valve 28 and the crucible 20 is moved with the crane 38 to receive molten metal from additional electrolytic cells until the crucible 20 is filled to capacity, typically with an 8500 kg load of molten metal.

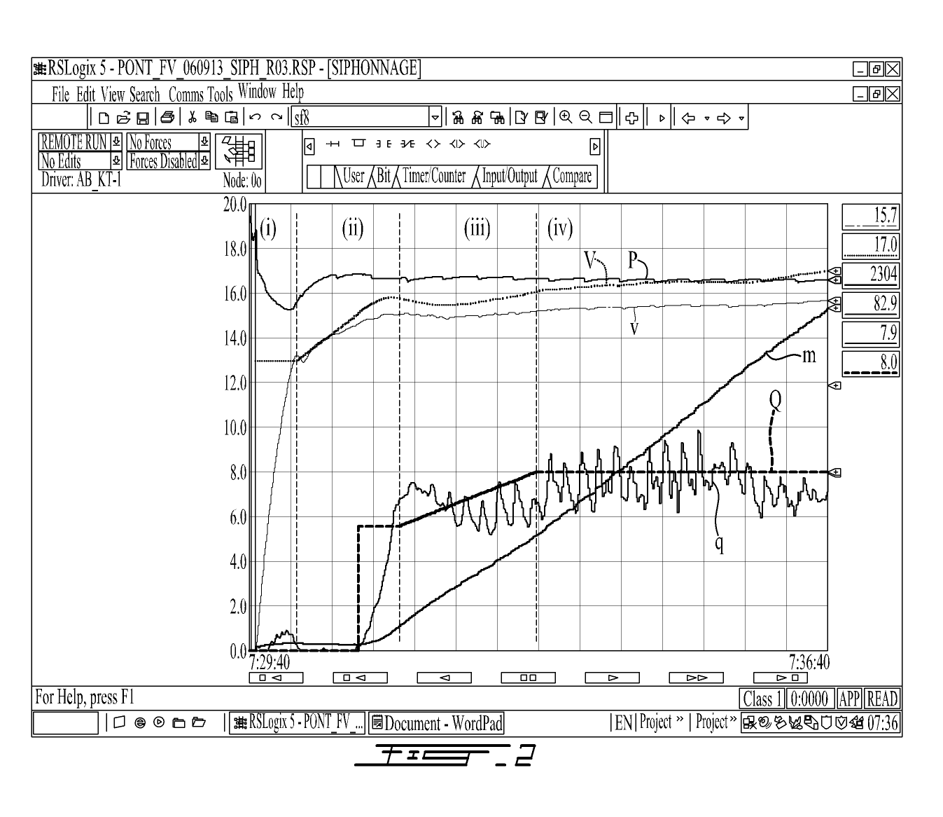

A target metal flow rate Q of metal being siphoned and actual metal flow rate q are monitored and controlled by a control unit which may include a programmable logic controller (PLC) 40 and control loop(s) which may be integrated into the crane controls (not shown) for the crane 38. Conveniently, the PLC 40 may be associated with a monitor to display the instantaneous metal flow rate q for observation by an operator. FIG. 2 is a screen print displaying a number of different lines each corresponding to operating parameters monitored by the PLC 40: 1) compressed air flow pressure P, 2) target vacuum set-point V, 3) actual vacuum v, 4) metal mass in crucible (and the siphon) m, 5) target metal flow rate Q, and 6) actual metal flow rate q of metal being siphoned.

The PLC 40, as shown in FIG. 1, is electrically coupled with solenoid 42 to main compressed air directional valve 28 to open the valve 28 when a siphoning operation begins and to close the valve 28 when the target mass M of metal has been siphoned into the crucible 20. For safety reasons, the PLC 40 is also electrically coupled with solenoid 43 to directional valve 29 to purge the incoming compressed air line of any accumulated moisture prior to starting a siphoning procedure. A pressure transducer 46 is coupled to a vacuum feedback pressure line 44 leaving the headspace 30 and provides the PLC 40 with a measure of the vacuum pressure in the crucible headspace 30.

A vacuum air regulator 48 controls the flow of compressed air through compressed air line 26 which supplies air ejector 22. The regulator 48 comprises an adjustable secondary compressed air control valve assembly 50. The regulator 48 has a valve actuator 49 for adjusting the secondary compressed air control valve assembly 50 in response to the vacuum feedback pressure in line 44 and a vacuum set-point V fed to the regulator 48 from the PLC 40 through an electrical current-to-pressure (I/P) converter 53 coupled to compressed air line 51.

As illustrated by the screen print shown in FIG. 2, the PLC 40 continuously determines the vacuum set-point V (and, thus, the flow rate of the motive fluid passing through the ejector 22) throughout the siphoning procedure. In a first stage of siphoning (i), the crucible 20 and siphoning tube 32 must be primed to initiate metal flow into the crucible 20. With the onset of a vacuum being applied to the headspace 30, some metal is aspired from an electrolytic cell and raised into the siphoning tube 32 without reaching the crucible 20. In FIG. 2, this appears as a transient trace of instantaneous metal flow q without any accumulation of metal mass m in crucible 20 but with a very small metal mass accumulation in the siphoning tube 32. According to one application, the initial vacuum set-point V is set to about 13 inches of Hg for a period of about 30 seconds. It will be appreciated that when the crucible 20 is empty of hot metal 34, a longer time is required to prime the crucible 20 and siphon 32 than when the crucible 20 is nearing capacity and the headspace 30 occupies a smaller volume.

It will be appreciated that during this first stage (i), the PLC 40 is not fully activated and does not yet control the metal flow rate q.

In a second stage of siphoning (ii) having a typical duration ranging from 1 to 2 minutes, the vacuum set-point V is gradually increased by the PLC 40 until the instantaneous metal flow rate q (a calculated value) of metal being siphoned into the crucible 20 reaches a predetermined fraction of the initial target metal flow rate Q. The initial target flow rate Q is lower than the steady state target flow rate Q to compensate for an actual flow rate q that inevitably overshoots the target flow rate Q. At this time, the feedback loop from the crucible 20 through the pressure transducer 46 to the PLC 40 to control the regulator 48 is fully activated.

In a third stage of siphoning (iii), the fluid flow rate of the motive fluid through the ejector 22 and, thus, the vacuum set point V is continuously adjusted so that the metal flow rate q is fully controlled by the PLC 40 control loop(s) to correspond to the target metal flow rate Q. In this manner, small adjustments are made to the actual vacuum v being applied to the crucible 20. During this third stage of siphoning (iii), the target metal flow rate Q is progressively raised up to the steady state flow target (for instance about 9 Kg/sec).

It will be observed from FIG. 2 that there is an accumulation of metal 34 into the crucible 20 and the metal mass m in crucible 20 increases. It will be appreciated that a very small adjustment in the vacuum will create a very large difference in the metal flow rate q. This is illustrated by the relatively constant line in FIG. 2 showing actual vacuum v and the large fluctuations in the instantaneous metal flow rate q of metal being siphoned. A very large portion of the vacuum applied to the crucible 20 is needed to raise the metal through the siphon tube 32 to reach the height of the crucible 20 and only a small fraction of the vacuum is directly related to adjusting the metal flow rate. This is why an automatic control of the siphoning process is used to provide the fine adjustments in vacuum that will maintain an ideal metal flow rate which maximizes productivity without compromising quality. By contrast, when such adjustments to control valve assembly 50 are done manually, as in the prior art, a very light touch is required so as not to overshoot the target metal flow rate Q.

In a fourth and final stage (iv) of the siphoning process, the instantaneous metal flow rate q is adjusted to match the steady state target metal flow rate Q and siphoning is stopped when the metal mass m in crucible 20 reaches the target mass M, usually after an interval of about 5 minutes from the beginning of the second stage of siphoning.

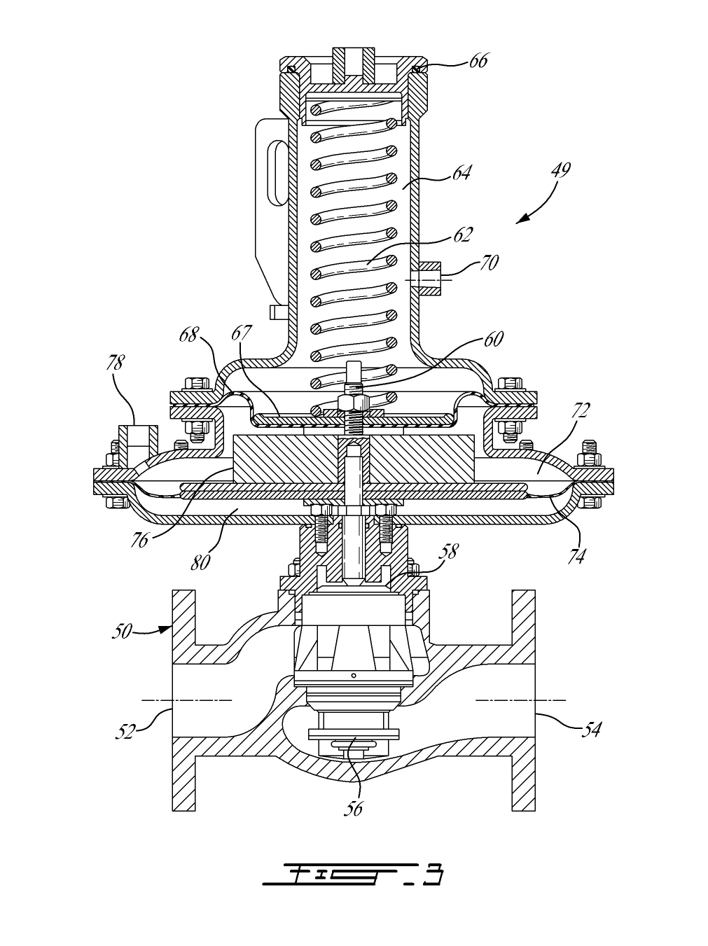

The operation of the regulator 48 and associated valve assembly 50 will now be described with reference to a specific embodiment developed for this application which is illustrated in FIG. 3. A standard Fisher 133HP pressure regulator was heavily modified in order to provide continuous fine vacuum adjustments required to be responsive to wildly fluctuating changes in measured actual flow rates q.

The secondary compressed air control valve assembly 50 has a valve housing or body defining a primary compressed air inlet 52 and compressed air outlet 54. The control of air through the valve assembly 50 is regulated by a valve member 56 shown in FIG. 3 in the fully open position. This model has an auxiliary chamber 58 to provide compensation for variable differential pressures between the air inlet 52 and air outlet 54. The valve member 56 may be closed or partially closed to adjust the air flow/pressure exiting through the air outlet 54 by changing the height of vertically extending valve stem 60 that extends through the valve assembly 50 and into the valve actuator 49. A very light pre-load is applied to valve stem 60 by means of a biasing member, such as a coiled spring 62 disposed in vacuum chamber 64 between a sealed rigid top 66 and a rigid bearing surface which may be provided in the form of a washer 67 disposed on a first flexible diaphragm 68. The vacuum chamber 64 has an inlet 70 which, in use, is operatively coupled to the vacuum feedback pressure line 44 (see FIG. 1).

The body of the vacuum chamber 64 is bolted to the body of a pressure chamber 72 disposed below the vacuum chamber 64. The first flexible diaphragm 68 extends across the bottom of vacuum chamber 64 and is sealed between the vacuum chamber 64 and the pressure chamber 72. A second diaphragm 74 extends across the bottom of the pressure chamber 72 and is sealed between the pressure chamber 72 and a vented chamber 80. The pressure chamber 72 has a compressed air inlet 78 which, in use, is operatively coupled to the compressed air line 51 (see FIG. 1) which is modulated through the electrical current-to-pressure (I/P) converter 53. It will be understood that the pressure in pressure chamber 72 in turn defines the target vacuum set point V. A block of inert packing or stuffing 76 is disposed in the pressure chamber 72 between the first and second diaphragms 68 and 74 to reduce the effective volume of the pressure chamber 72 and to improve the responsiveness of the regulator 48 to small pressure variations in compressed air line 51.

The vented chamber 80 is open to atmospheric pressure through an air filter (not shown).

In operation, the position of valve stem 60 will fluctuate to control compressed air exiting compressed air outlet 54 thereby regulating the vacuum induced in the crucible headspace 30. The displacement of the diaphragms 68 and 74 in turn controls the position of the valve stem 60.

The rest position of the valve member 56 is the fully open position illustrated in FIG. 1. In use, when compressed air is allowed to flow through the air ejector 22, a vacuum is induced in the headspace 30. The vacuum pressure varies according to the flow rate of the air flowing through the ejector 22. Accordingly, a reduced pressure is exhibited in vacuum feedback line 44 that communicates with vacuum chamber inlet 70. This results in an upward deflection of the upper diaphragm 68, effectively pulling on valve stem 60 to restrict air flow through the valve assembly 50.

It will be appreciated that the effective surface area of the second diaphragm 74 is greater than the surface area presented by the first diaphragm 68. Accordingly, an increase in the air pressure admitted through compressed air inlet 78 to the pressure chamber 72, as controlled by I/P converter 53, will have a greater influence on the larger diaphragm 74 and operate to lower the stem 60 so as to open the valve assembly 50 and increase air flow through the valve assembly 50.

It will be understood that even a very weak vacuum in vacuum chamber 64 operates to pull upwardly on the valve stem 60 so as to close the valve member 56 whereas an increase in the air pressure admitted to the pressure chamber 72 will operate to depress the valve stem 60 downwardly so as to open the valve member 56, thereby requiring an even greater vacuum in order to close it.

The air pressure regulator 48 thus provides means to continuously adjust the target vacuum set-point V in response to real time changes in the instantaneous metal flow rate being siphoned. This is a vast improvement over prior art regulators which have predetermined target vacuum set points. With regulator 48, the system may be operated to siphon metal at a predefined metal flow rate and to change the steady state target metal flow rate Q according to prevailing operating conditions. Also with the PLC 40 and the regulator 48, it is possible to change a pre-defined metal flow rate to a different target, as needed, by providing a new target to the PLC 40.

While it has been proposed to determine the actual flow rate q of liquid being siphoned by measuring the weight of the crucible 20 and using the PLC 40 to process the weight data in order to determine the actual flow rate q, it is also contemplated to directly measure the liquid flow rate q by connecting a flow meter or the like to the siphoning tube 32.

### INDEX OF REFERENCE NUMBERS

20 crucible
22 air ejector
24 compressed air supply
26 compressed air line
28 main compressed air directional valve
29 directional valve
30 crucible headspace
32 siphoning tube
34 liquid metal
36 scale
38 crane
40 PLC
42 solenoid
43 solenoid
44 vacuum feedback
46 pressure transducer
48 vacuum/air regulator
49 valve actuator
50 secondary compressed air control valve assembly
51a compressed air line to i/p converter
51b compressed air line from i/p converter
52 primary compressed air inlet
53 i/p converter
54 compressed air outlet
56 valve member
58 auxiliary chamber
60 valve stem
62 coil spring
64 vacuum chamber
66 top
67 washer
68 first diaphragm
70 vacuum chamber inlet
72 pressure chamber
74 second diaphragm
76 stuffing
78 secondary compressed air inlet
80 vented chamber
compressed air flow pressure p
target vacuum set-point V
actual vacuum v
target mass M
metal mass in crucible m
target metal flow rate Q
instantaneous metal flow rate of metal being siphoned q

What is claimed is:

1. A system for controlled siphoning of a liquid to be transferred at a pre-determined target flow rate Q into a container having a siphon communicating with a headspace for the container, the system having:
an air ejector coupled to a source of compressed air and in fluid communication with the headspace;
weighing means for measuring the weight of the container during siphoning;
a control unit operatively connected to said weighing means for receiving weight measurements and calculating instantaneous liquid flow rates q of liquid being siphoned into the container, the control unit having an output providing target vacuum set points V for continuously adjusting a flow rate of the compressed air flowing through the air ejector such that the actual flow rate q of the liquid being drawn into the container generally corresponds to said target flow rate Q; and
a vacuum regulator provided between the source of compressed air and the air ejector, and operatively connected to the control unit and a vacuum feedback pressure line from the headspace for regulating the flow of compressed air delivered to the air ejector in response to vacuum pressure changes in the headspace and to the target vacuum set-points V fed to the vacuum regulator by the control unit.

2. A system according to claim 1 in which the control unit is operatively connected to a pressure transducer sensing an actual vacuum pressure at said headspace during siphoning, the pressure transducer providing vacuum pressure feedbacks to the control unit.

3. A system according to claim 2 in which the control unit is associated with display means for showing operating parameters selected from the following group: compressed air flow pressure p, target vacuum set-point V, actual vacuum v, liquid mass in container m, target liquid flow rate Q, actual liquid flow rate q of liquid being siphoned.

4. A system according to claim 1 in which the vacuum regulator has an electrical current-to-pressure (I/P) converter operatively connected to the control unit for receiving control commands therefrom, the electrical current-to-pressure (I/P) converter being connected to the source of compressed air.

5. A system for controlled siphoning of a liquid to be transferred at a pre-determined target flow rate Q into a container having a siphon communicating with a headspace for the container, the system having:
an ejector operatively connected to a source of motive fluid, the ejector being in fluid communication with the headspace to cause liquid to be drawn into the container through the siphon as the motive fluid flows through the ejector,
a flow regulator provided between the source of motive fluid and the ejector for regulating the flow of motive fluid fed to said ejector, thereby providing for the adjustment of a vacuum pressure at said headspace;
a sensor for sensing an operating parameter indicative of an actual flow rate (q) of the liquid drawn into the container; and
a control unit adapted to:
use the operating parameter from the sensor to determine an adjustment value of a flow rate of the motive fluid for the actual flow rate (q) to generally correspond to the pre-determined target flow rate (Q), and controlling the flow regulator to regulate the flow rate of the motive fluid in accordance with the adjustment value.

6. The system defined in claim 5, wherein the sensor has a pressure transducer for sensing an actual vacuum pressure at the headspace, the pressure transducer being operatively connected to the control unit for providing vacuum pressure feedback thereto.

7. The system defined in claim 5, wherein a weighing unit is provided for continuously sensing an actual weight of the container while the liquid is being drawn into the container, the weighing unit being operatively connected to the control unit, the control unit processing the weight sensed by the weighing unit to calculate the actual flow rate of the liquid being drawn into the container.

8. The system defined in claim 7, wherein the weighing unit has a scale.

9. The system defined in claim 5, wherein the flow regulator has a valve assembly operated by a valve actuator having a vacuum chamber having a first inlet connected in fluid flow communication with the headspace, and a pressure chamber having a second inlet operatively connected with a pressure outlet of a current-to-pressure converter which is, in turn, operatively connected to the control unit and to the source of motive fluid upstream of the valve assembly.

10. The system defined in claim 5, wherein the flow regulator comprises a valve assembly operated by a valve actuator responsive to an electric current-to-pressure converter which is coupled to the control unit.

11. A valve actuator adapted to be coupled to a valve assembly having a housing defining a primary inlet and an outlet, a valve member received in said housing for regulating a fluid flow between the primary inlet and the outlet, and a valve stem extending from the valve member through the housing; the valve actuator having a vacuum chamber sealed from a pressure chamber, the vacuum chamber having a vacuum chamber inlet and a first diaphragm responsive to fluid pressure in said vacuum chamber, the first diaphragm being coupled to the valve stem, the pressure chamber having a secondary inlet and a second diaphragm responsive to fluid pressure in said pressure chamber and coupled to said valve stem, both said first and second diaphragms being adapted to move the valve stem to control the position of the valve member and determine the fluid flow through the outlet of the valve assembly. A valve actuator according to claim 11 in which the first diaphragm is disposed between the vacuum chamber and the pressure chamber.

12. A valve actuator according to claim 11 in which the second diaphragm is disposed between the first diaphragm and an exterior wall, the second diaphragm and the exterior wall defining a vented air chamber open to ambient air pressure.

13. A valve actuator according to claim 11 in which the second diaphragm has a larger effective area than the first diaphragm so that changes in air pressure admitted to the pressure chamber have a greater influence on the second diaphragm than the first diaphragm.

14. A valve actuator according to claim 11 having a packing to occupy volume in said pressure chamber and increase responsiveness to small variations in air volume.

15. A valve actuator according to claim 11 in which the vacuum chamber has a biasing member to bias the valve member into an open position.
